(19) United States
(12) Patent Application Publication
(10) Pub. No.: US 2024/0303571 A1
(43) Pub. Date: Sep. 12, 2024

(54) AUTOMATED RISK CONTROL

(71) Applicant: Capital One Services, LLC, McLean, VA (US)

(72) Inventors: Erik MUELLER, Chevy Chase, MD (US); Jaime MANTILLA, Cranford, NJ (US); Tanusree Datta MCCABE, Washington, DC (US)

(73) Assignee: Capital One Services, LLC, McLean, VA (US)

(21) Appl. No.: 18/118,230

(22) Filed: Mar. 7, 2023

(51) Int. Cl. G06Q 10/0635; G06Q 10/0633

(52) U.S. Cl. CPC G06Q 10/0635; G06Q 10/0633

(57) ABSTRACT

Disclosed herein are system, method, and computer program product embodiments for processing risk mitigation controls. The system analyzes text to determine control components located within the text, where the text defines one or more measures to provide assurance of compliance with organizational process requirements. The system further maps, by machine learning models, the control components to a process executable model workflow based on corresponding control code. Upon receiving a trigger, the system automatically instantiates the process model workflow and executes tasks of the control code, monitors a status of the tasks, captures an audit record of the execution and streams the audit record to an uneditable archive.

### BACKGROUND

Because business process controls are not designed into system architectures from the beginning, automation, codification, testing, monitoring, and enforcement of controls may be compromised. For example, risk mitigation systems may lack real-time visibility into a current status of corresponding controls. In addition, it may be difficult to gather evidence of controls during audits.

### BRIEF DESCRIPTION OF THE DRAWINGS

The accompanying drawings are incorporated herein and form a part of the specification.

FIG. 1 is a block diagram for generating and managing controls, according to some embodiments.

FIG. 2 is a flow diagram for controls, according to some embodiments.

FIG. 3 is a block diagram for managing controls, according to some embodiments.

FIG. 4 is a flow diagram for processing controls with machine learning, according to some embodiments.

FIG. 5 is a block diagram for natural language processing of a control content, according to some embodiments.

FIG. 6 is a block diagram for processing controls with machine learning, according to some embodiments.

FIG. 7A is an example of control mapping, according to some embodiments.

FIG. 7B is an example of monitoring controls, according to some embodiments.

FIG. 8 is a flow diagram for controls processing, according to some embodiments.

FIG. 9 is an example UI dashboard for monitoring controls, according to some embodiments.

FIG. 10 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof for automated risk control development. Controls are manual, automated or hybrid auditable activities that prevent or detect business process errors in service of mitigating risks to a business.

In some embodiments, the technology described herein implements a system that analyzes risk mitigation text to determine control components located within the text, where the text defines one or more measures to provide assurance of compliance with organizational process requirements. The system further maps, by machine learning models, the control components to a process executable model workflow based on a corresponding control code. Upon receiving a trigger (e.g., scheduled time of execution), the system instantiates a process model workflow and executes tasks of the control code. During execution of the process model workflow, the system monitors a status of the tasks, captures an audit record of the execution and streams the audit record to an uneditable archive.

In some embodiments, the technology disclosed herein provides a framework that utilizes machine learning (ML) models to extract controls segments from structured or unstructured control text. In a non-limiting example, the technology disclosed herein provides machine learning and natural language processing models for automatically learning how to map text to codified controls in the form of business process models, rules, control code and procedures. In some embodiments, the technology described herein implements a plurality of machine learning models related to controls combined in an infrastructure to support controls in real-time while interacting with managers and auditors. The technology described herein improves the technology associated with controls by, at a minimum, properly extracting structured control processes from unstructured control descriptions.

In some embodiments, the technology disclosed herein provides a systematic codification of an organization's risk controls. For example, the technology disclosed herein provides a codification of controls as business process models, including controls requiring human approval as one of the steps.

In some embodiments, the technology disclosed herein provides automatically locating suitable existing controls for new or amended laws, regulations, policies, standards, and procedures using machine learning and natural language processing models.

In some embodiments, the technology disclosed herein provides continuous monitoring and testing of controls. In a non-limiting example, the technology disclosed herein provides a user interface (UI) dashboard for viewing the status of all controls in real-time relative to an entire organization or a subset of the organization.

In some embodiments, the technology disclosed herein provides for audit evidence gathering. For example, the technology disclosed herein may implement streaming of control-related activity to an uneditable archive and synch with corporate systems of record. In some embodiments, the technology disclosed herein provides a secure archive of all controls-related activity to support the dashboard and audits.

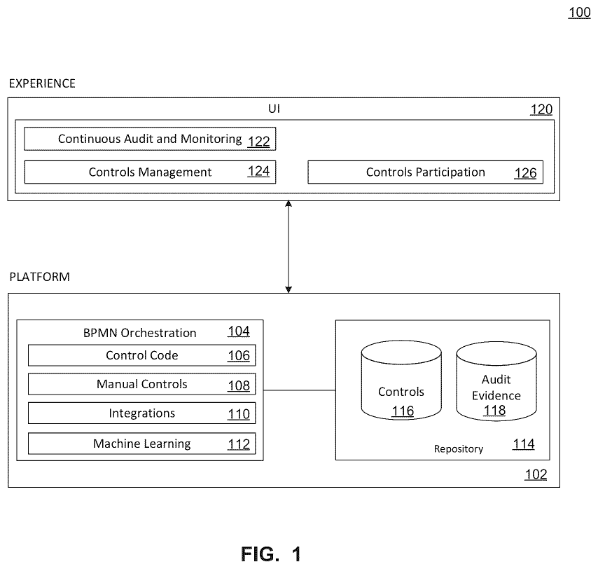

Therefore, the technology described herein solves one or more technical problems that exist in the realm of online computer systems. One problem, proper control code generation, prevents other systems from properly correlating controls with corresponding control solutions (e.g., based on correctly identified control parts and relationships between those parts). The technology as described herein provides an improvement in controls generation and processing. Therefore, one or more solutions described herein are necessarily rooted in computer technology in order to overcome the problem specifically arising in the realm of computer networks. The technology described herein reduces or eliminates the problem of an inability for a computer to properly capture correct control rules, generate corresponding control code and provide an uneditable audit record as will be described in the various embodiments of FIGS. 1-9.

FIG. 1 is a block diagram for an automated risk control system, according to some embodiments. Automated risk control system 100 may be implemented by hardware (e.g., switching logic, communications hardware, communications circuitry, computer processing devices, microprocessors, dedicated logic, programmable logic, microcode, etc.), software (e.g., instructions executing on a processing device), or a combination thereof. It is to be appreciated that not all components may be needed to perform the disclosure provided herein. Further, some of the processes described may be performed simultaneously, or in a different order or arrangement than shown in FIG. 1, as will be understood by a person of ordinary skill in the art. Automated risk control system 100 shall be described with reference to FIG. 1. However, automated risk control system 100 is not limited to this example embodiment.

Risk control is a plan-based business strategy that aims to identify, assess, and prepare for any dangers, hazards, regulatory or governance compliance issues, and other potentials for loss or exposure that may interfere with an organization's operations and objectives. As illustrated, automated risk control system may, in some embodiments, include a control platform 102 to codify rules that reduce or reveal exposures to risk based on business process rules. Codification of the controls is implemented by arranging business rules into a systematic code. Codified controls may be subsequently monitored and audited with results rendered on a user interface (UI) 120.

Business Process Model and Notation (BPMN) Orchestration 104 is a flow chart method that models steps of a planned business process from end-to-end. As a business process management, it visually depicts a detailed sequence of business activities and information flows needed to complete a process. A BPMN implementation will run control code 106 of a control that ensures that corresponding business rules for the planned business process are followed and completed. Codified controls are stored as Controls 116 in Repository 114.

As a BPMN implementation for a selected control progresses, the various inputs, outputs, tasks and actions are archived as future Audit Evidence 118 and stored and retrieved from Repository 114. While shown as separate databases (DBs), Controls 116 and Audit Evidence 118 may be stored in any known computer storage configuration. For example, the Controls 116 and Audit Evidence 118 may be stored locally, remotely, in a cloud-based system, in a distributed storage system, etc. In addition, the audit evidence is stored securely (e.g., uneditable) to prevent tampering. Security may include, but is not limited to, encryption, encoding, firewall protection, block-chain systems, electronic ledgers, etc. Uneditable is defined as the audit evidence remaining in its original state. In addition, for security purposes, the audit evidence should not be subject to cyber threats, such as, Structured Query Language (SQL) injection, Denial of Service (DoS) attacks, data breaches, etc.

While BPMN has been described to model business processes, other known or future models or standards may be substituted without departing from the scope of the technology described herein. In one non-limiting example, Decision Model and Notation (DMN) standards may implement business processes. In business analysis, DMN represents a standards based approach for describing and modeling repeatable decisions within organizations to ensure that decision models are interchangeable across organizations. In another non-limiting example, a BPM-based process engine may implement business processes. A BPM-based process engine platform is a modeling application for deploying automated processes, human workflows, decision tables, and decision requirements diagrams. It offers non-Java developers an Application Programming Interface (API) and dedicated client libraries to build applications connecting to a remote workflow engine. There are known commercial and open source options that implement BPM standards.

Integrations 110 arrange a plurality of different controls as needed for a specific business process. For example, a business process may include a sequence (or branching) of a plurality of controls. The use of BPMN affords the ability to represent, store, act on and monitor different types of activities in the controls process, including Manual Controls 108 that require user intervention in system as well as Integrations 110 that allow for electronic integration into systems affected by the controls so that the control system can implement and monitor the execution of those controls without user intervention.

Machine learning 112 component trains and implements control models to map and monitor control descriptions into business process models, rules, control code and procedures. In addition, the machine learning 112 component may automatically locate suitable existing controls for new or amended laws, regulations, policies, standards and procedures.

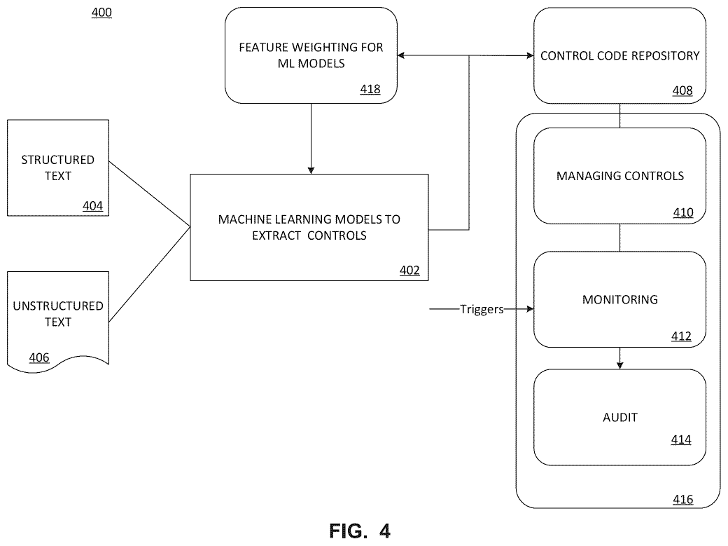

A machine learning system may include a machine learning engine of one or more servers (cloud or local) processing text, such as words, phrases or sentences, to recognize relationships of the words (e.g., within sentences) received by an interface of a natural language system. For example, a risk manager enters, into the UI, a risk mitigation textual description of a control they are constructing. The textual description may be structured (e.g., using known control constructs) or unstructured (e.g., freeform). The natural language processor may break down the structured or unstructured text to determine control related “parts” and a context of these parts. The control parts may describe various control concepts, such as, inputs, outputs, parties involved, risk levels, standards, triggers, actions, mitigation steps, tasks, follow-up, etc. Trained machine learning models, such as a Control Mapping Model, receive this information from the NLP and extract or infer relationships of these control parts to generate, for example, controls as business process models, rules, control code and/or procedures. Additional detail for machine learning will be provided in association with FIGS. 4-7.

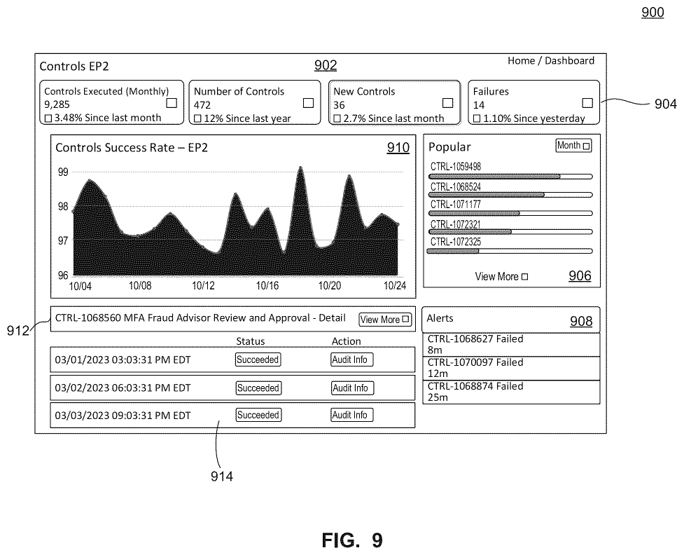

User Interface (UI) 120 provides an interface to reveal a real-time status of the controls relative to an entire organization, division, department, product line, location, etc. The UI may include a Continuous Audit and Monitoring 122 component (e.g., as shown in FIG. 9), a Controls Management 124 component (e.g., an audit) and a Controls Participation 126 component. Continuous Audit and Monitoring 122 component may display to a user, control based status information, such as, but not limited to, a number of controls executed, frequency of execution, newly added controls, failures, success rate, alerts and individual control status and action information. Controls Management 124 component provides user control of which controls will be selected in the UI display outputs, which information will be selected for display, and any selectable control triggers (e.g., schedule) for running controls. Controls Participation 126 component displays steps in a business process flow that may require manual intervention. For example, a business process flow may require a manual control 108, such as, a signature or notarization process, to be complete. The UI may display one or more of these manual steps and reflect the completion or failure of these steps. The manual step status will be recorded by the controls platform 102 for memorialization in the audit evidence.

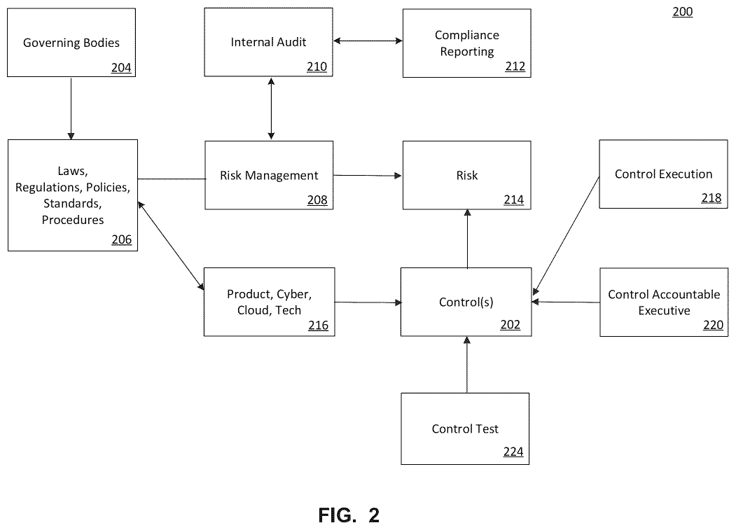

FIG. 2 illustrates an example control system 200 processing a control(s) 202, as per some embodiments. System 200 can be implemented by hardware (e.g., switching logic, communications hardware, communications circuitry, computer processing devices, microprocessors, dedicated logic, programmable logic, microcode, etc.), software (e.g., instructions executing on a processing device), or a combination thereof. It is to be appreciated that not all components may be needed to perform the disclosure provided herein. Further, some of the processes described may be performed simultaneously, or in a different order or arrangement than shown in FIG. 2, as will be understood by a person of ordinary skill in the art.

System 200 shall be described with reference to FIG. 2. However, system 200 is not limited to this example embodiment. In addition, system 200 will be described at a high level to provide an overall understanding of one example control flow. Greater detail will be provided in the figures that follow.

In a non-limiting example, control(s) 202 may implement risk mitigation aspects to monitor business processes or compliance with regulatory or legal requirements. For example, governing bodies handle review and compliance with various business practices, such as, but not limited to, company reporting, financial operations and reporting, consumer protection, legal compliance, marketing and advertising, public disclosures, product and employee safety requirements, human resources, sales, etc. Each of these governing bodies 204, may generate, monitor and enforce specific laws, regulations, policies, standards, and procedures 206, to name a few. Governing bodies 204 hold accountability to stakeholders for organizational oversight and roles, such as, integrity, leadership and transparency. For a company to assure their own compliance with these requirements of governing bodies, a risk management system 208 may initiate internal audits 210 and compliance reporting 212 based on how closely the business complies with business rules defined by controls 202. Audits may be carried out by identifying individual risks 214 that may be present within each internal process followed by a company, division, location, sector, department, team or individual. Audits should reflect independent and objective assurance on matters related to the achievement of the business objectives. Audits may be sourced internally or externally (e.g., government agency audit). Internal audits may further include advice based on the audit. External audits may be needed for regulatory or judicial oversight.

In some embodiments, the technology disclosed herein implements digitization of the policies referred to in procedures 206 into rules. These policies may be recorded using a data model that then supports a rules based engine to determine the applicability of the policies to a given subject (an application or feature for example). The controls that apply to that subject will be determined by running these rules.

To monitor these identified risks 214, a control 202 is generated that follows a specific set of business rules and can be compared against company practices. As each control 202 is generated, a control test 224 may also be generated to determine if the computer code from the control will capture or reveal compliance or non-compliance when run against actual practices. Each control will be executed by control execution 218. Product, Cyber, Cloud and Tech 216 represent the internal participants who define the controls based on interpretation of the Laws, Regulations, Policies, Standards, Procedures 206. Product, Cyber, Cloud and Tech 216 may review and assure that controls 202 meet the criteria specified in 206. Product is defined as a Product Management (a role that manages the intent, priority and functionality required in a product). Cyber is defined as Cyber Security (a role that manages the controls, procedures and standards for Information Security). Cloud is defined as Cloud Engineering (a role that manages the controls, procedures and standards for application deployment, service usage and other controls in our infrastructure environment, which is in the cloud). Tech is defined as Technology Management and Engineering (a role that designs, builds, deploys and manages the software systems that are subject to the Controls).

Individual controls would roll up to monitor company-wide compliance with the laws, regulations, policies standards and procedures. Control execution system 218 implements the controls, determines frequency of execution, timing of execution, completion, follow-up, etc. Control Execution 218 may support different modes. For example, control can be executed as an embedded logic within the observed controlled system, as an external monitor of the observed controlled system or as an attestation provided by delegates of the Control Accountable Executive 220 on behalf of the observed controlled system.

In addition, each control or combination of controls may be owned by a control accountable executive 220, such as a manager, a location supervisor, a division manager, product line manager, etc. While designated as a person (e.g., executive), a control accountable executive may also be a generic designee, such as a specific department, location, profit center, or product line that will own the control. The management of an entity may need to take actions to insure reduction of risk by achieving organizational objectives, accounting objectives, sales objectives, legal compliance, regulatory compliance, and implementation of best practices.

In a non-limiting workflow example, a risk manager first identifies a risk, formulates a control to mitigate the risk (e.g., textual description or workflow) and enters the control into a Management UI 318. A machine learning model automatically converts the control into a business process model and notation (BPMN) workflow. The risk manager may choose to post-edit the BPMN workflow for accuracy using the self-service UI. Alternatively, or in addition to, the machine learning system may automatically convert the control to other known or future business process workflows (e.g., DMN), policies, rules or control code). Once created, a new control is added to the controls system of record (e.g., a listing of available controls) and stored in a tamperproof executions archive (e.g., Repository 114). At a time in the future, a control is triggered by a scheduler, monitoring, or events, where steps of the control are executed automatically. However, if one or more steps of the control is manual, a human completes the step using the Management UI 318. For purposes of retaining a record of the execution for later audit purposes, the execution of all manual and automated steps of the control is streamed to the tamperproof executions archive (e.g., Repository 114). UI 120 displays execution of the control and may display summary information about currently active controls. At a later time, an audit may be requested. All activity and details relating to a particular control and its execution are retrieved from the executions archive and displayed.

In one non-limiting example, a control may follow business rules that state that a specific regulatory disclosure must be read to a customer during a call center communication about a corresponding specific financial product. The control would recognize the parties involved, financial product, the corresponding regulatory disclosure and a method of extracting and comparing the words spoken to the caller to determine compliance.

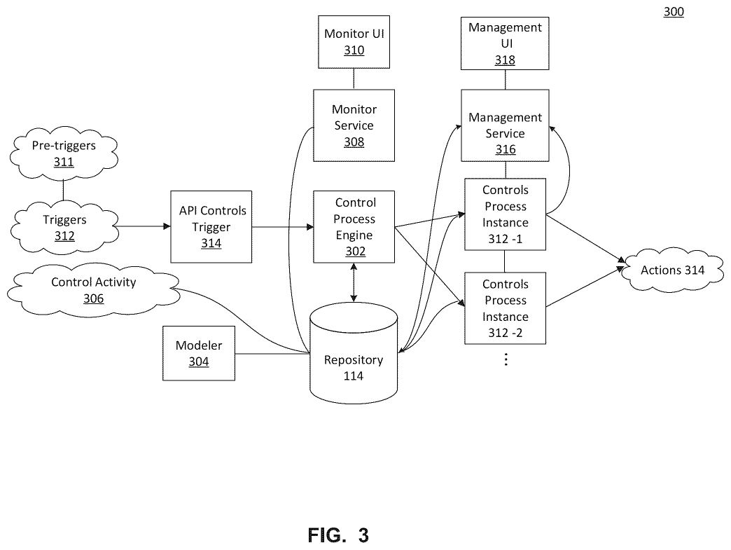

FIG. 3 illustrates an example control system 300 processing an incoming control, as per some embodiments. Control system 300 can be implemented by hardware (e.g., switching logic, communications hardware, communications circuitry, computer processing devices, microprocessors, dedicated logic, programmable logic, microcode, etc.), software (e.g., instructions executing on a processing device), or a combination thereof. It is to be appreciated that not all components may be needed to perform the disclosure provided herein. Further, some of the processes described may be performed simultaneously, or in a different order or arrangement than shown in FIG. 3, as will be understood by a person of ordinary skill in the art.

Control system 300 shall be described with reference to FIG. 3. However, control system 300 is not limited to this example embodiment. In addition, control system 300 will be described at a high level to provide an overall understanding of one example of controls flow. Greater detail will be provided in the figures that follow.

As illustrated, control system 300 may implemented with a Control Process Engine 302. Control Process Engine 302 may generate and implement controls and be instantiated in multiple control based configurations and standards without departing from the scope of the technology described herein. Control based configurations allow different execution scenarios, for example, a control can be instantiated as an embedded component within a controlled system to evaluate the control rules as the controlled system executes. A control can be instantiated as a remote monitor that records an audit stream from the controlled system. A control can also be instantiated as an automatically generated task for a user to attest that the controlled system meets the requirements of said control

Control Process Engine 302 may be implemented as a Business Process Model and Notation (BPMN) process engine. BPMN is a flow chart method that models the steps of a planned business process from end to end. A key to business process management, it visually depicts a detailed sequence of business activities and information flows needed to complete a process. A BPMN implementation of Control Process Engine 302 will run the control code of a BPMN control that ensures that corresponding business rules for the planned business process are followed and completed. Codified controls are retrieved from Repository 114 (e.g., from Controls 116). Audit data is returned to Repository 114 to archive as Audit Evidence 118.

Alternatively, or in combination, Control Process Engine 302 may be implemented as a BPM-based process engine. However, BPM-based process engines are just one example of available processing engines that can be used. The use of BPMN allows the implementation of the Controls as Code system using any off the shelf or open source tools that implement the BPMN standard.

A BPM-based process engine is an application for deploying automated processes, human workflows, decision tables, and decision requirements diagrams using BPMN and Decision Model and Notation (DMN) standards. In business analysis, DMN represents a standards based approach for describing and modeling repeatable decisions within organizations to ensure that decision models are interchangeable across organizations. A BPM-based process engine implementation of Control Process Engine 302 will run the control code of a BPM-based process engine control that ensures that corresponding business rules for the planned business process are followed and completed.

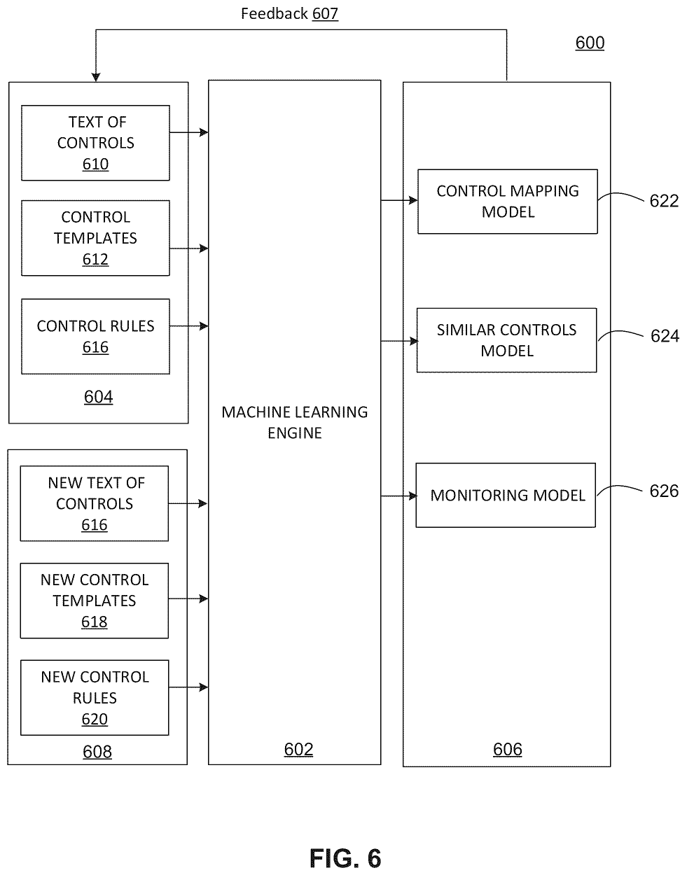

Alternatively, or in combination, Control Process Engine 302 may be implemented as Machine Learning Engine 602 (FIG. 6). Control Process Engine 302 may generate codified rules based on extracting or inferring rules based, for example, on previously created rules or rule templates. A Machine Learning implementation of Control Process Engine 302 will run the control code of a machine learning generated control that ensures that corresponding business rules for the planned business process are followed and completed. Generated rules and audit evidence are stored for later retrieval from Repository 114. ML is in combination with the process engine (which manages the state of a control lifecycle). In some embodiments, the processing engine has stages where ML models will be used. For example, a ML model, using Natural Language Processing, can extract metadata about policy language so it that it may be turned into a data model for the control. A different ML model may be used to determine if a control applies to a subject as part of the decision making process. Additionally, a ML model can be used to monitor compliance and audit the execution of a Control.

Modeler User Interface (UI) 304 provides a user interface to define models and rules needed by the Control Process Engine 302. For example, the Modeler UI may receive structured or unstructured text describing a business process control for NPL 502 and Machine Learning Engine 602. In another example, the Modeler may import BPMN models used to develop specific business processes as well as the steps of a planned business process. In another example, the Modeler may import DMN or other known or future business standards.

A pre-trigger 311 or trigger 312, such as a scheduled control execution time, frequency for control execution (e.g., weekly, monthly, etc.), specific event, or specific request, to name a few, instantiates a controls process execution instance. A pre-trigger is defined as a business activity execution of the application or process that is subject to the control. At certain points or milestones, this business activity may, in of itself, or in combination with other activities, trigger a control activity. For example, if a business user wants to define a new intent for a product that is being developed, pre-trigger activity may include the business user requesting the intent and separately, requesting a new product reference data entry. At some point the combination of activities here will trigger a control that may kickoff a review process for product development and compliance checking based on the risk related to the type of intent and the type of Product. An application programmable interface (API) 314 communicates the pre-triggers 311 and triggers 312 to the control process engine 302 to initiate a control process instance 312-1 (i.e., occurrence) of the control as it is processed. A second trigger may instantiate a second controls process instance 312-2, et al.

Control Activity 306, such as processing a specific control (e.g., retrieved from Repository 114) when a corresponding business process is being executed, will initiate a corresponding monitor service 308. Monitoring service 308 implements a monitoring process UI (e.g., see FIG. 9) which is rendered and continuously updated on Monitor UI 310.

Following from the earlier example, when a customer calls a call center to discuss a specific financial product, a trigger 312, such as one or more words keywords spoken by the customer, may initiate a control activity and monitoring process. For example, words spoken by the customer may be processed through NPL 502 to detect trigger keywords, phrases, or events, such as, “what is the rate on the credit card that you are offering?” These keywords may trigger a credit card disclosure control to determine if the call agent discussing the issue with the customer reads an appropriate regulatory disclosure. The credit card disclosure control will instantiate an instance of the control's implementation of monitoring whether the regulatory document has been read and read correctly (or not) and may include actions 314, such as directing the call agent to reread one or more parts of the regulatory disclosure when not properly read. The details of each control instance (e.g., success, failure, tasks, actions taken, etc.) reflecting the business process followed will be memorialized for later audit in Repository 114.

For each control instance (e.g., each customer or business interaction), Management Service 316 provides a platform for interacting with the control instance and Management UI 318 with respect to this control instance or an aggregation of instances (e.g., over a determined time period). Management Service offers the application runtime for a user of the Management UI to configure the controls. Configuration of the controls allows for different user types to interact with the system, for example, there are users who will be able to configure and digitize the policies, users who will configure the controls and rules associated with those controls (e.g., how frequently they run, what triggers are associated), users who will define process flows that manage the lifecycle of a control for any given instance. In addition, there is the Management UI 318 that gives users access to tasks that manual controls create so that they can act on those controls.

FIG. 4 illustrates an example machine learning system 400 processing a control, as per some embodiments. Machine learning system 400 can be implemented by hardware (e.g., switching logic, communications hardware, communications circuitry, computer processing devices, microprocessors, dedicated logic, programmable logic, microcode, etc.), software (e.g., instructions executing on a processing device), or a combination thereof. It is to be appreciated that not all components may be needed to perform the disclosure provided herein. Further, some of the processes described may be performed simultaneously, or in a different order or arrangement than shown in FIG. 4, as will be understood by a person of ordinary skill in the art.

Machine learning system 400 shall be described with reference to FIG. 4. However, machine learning system 400 is not limited to this example embodiment. In addition, machine learning system 400 will be described at a high level to provide an overall understanding In addition, system 400 will be described at a high level to provide an overall understanding of one example control processing flow from initial rule descriptions to final codified rule processes. Greater detail will be provided in the figures that follow.

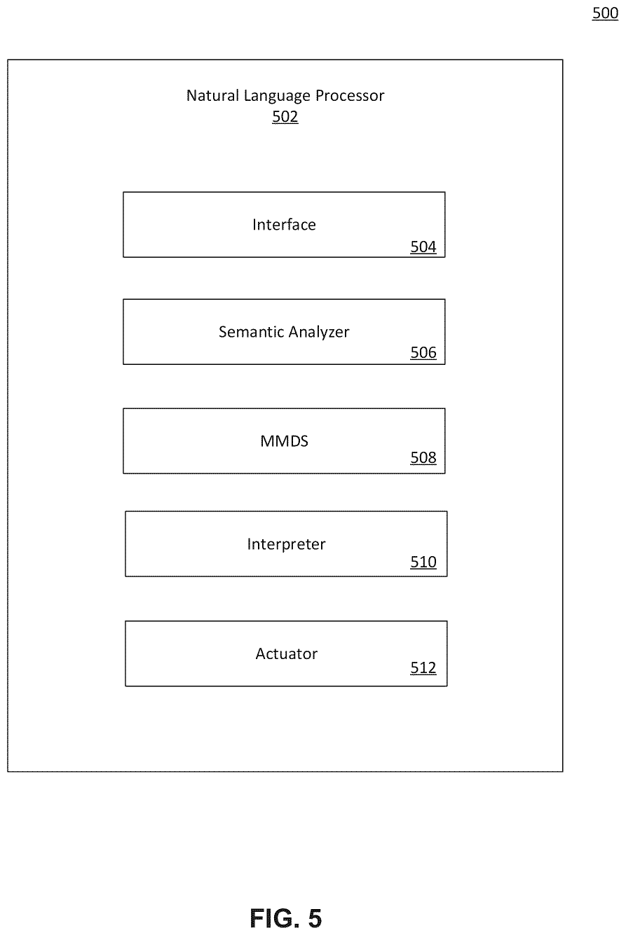

Structured text 404 or unstructured text 406 (e.g., freeform) that describe a control may be analyzed by a natural language processor (NLP) 502, as described in greater detail in association with FIG. 5. For example, the natural language processor may break down a series of structured or unstructured text segments related to controls to determine the “parts” and context of these parts. In a non-limiting example, control parts may describe various risk control concepts, such as, inputs, outputs, actions, tasks, entities involved, risk levels, standards, legalese, triggers, mitigation steps, follow-up, etc. On or more trained machine learning models 606 receive these parts and any derived context from the NLP 502 and extract or infer relationships of these control parts to generate controls as business process models, rules, control code and procedures that may be collected as Controls 116 in Repository 114. In computer programming, code refers to a set of instructions, or a system of rules, written in a particular programming language (i.e., the source code). It is also the term used for the source code after it has been processed by a compiler and made ready to run on the computer (i.e., the object code). The control code may subsequently be implemented in an automated system 416 for managing controls 410, monitoring controls 412 (e.g., based on triggers) and auditing 414.

In some embodiments, the generated controls may be used for training downstream ML models to increase effectiveness of one or more of the rules related models' in understanding future rules development. For example, the controls may be implemented in future weighting of related control ML models 606. In a non-limiting example, these controls may be implemented as future weighted features for ML models—control mapping 622, similar controls 624 or controls monitoring 626 (FIG. 6).

FIG. 5 illustrates an example NLP system 500 processing an incoming control, as per some embodiments. NLP system 500 can be implemented by hardware (e.g., switching logic, communications hardware, communications circuitry, computer processing devices, microprocessors, dedicated logic, programmable logic, microcode, etc.), software (e.g., instructions executing on a processing device), or a combination thereof. It is to be appreciated that not all components may be needed to perform the disclosure provided herein. Further, some of the processes described may be performed simultaneously, or in a different order or arrangement than shown in FIG. 5, as will be understood by a person of ordinary skill in the art.

NLP system 500 shall be described with reference to FIG. 5. However, system 500 is not limited to this example embodiment. In addition, NLP system 500 will be described at a high level to provide an overall understanding In addition, NLP system 500 will be described at a high level to provide an overall understanding of one example control processing flow from initial rule descriptions to final codified rule processes. Greater detail will be provided in the figures that follow.

As illustrated, NLP system 500 may be implemented with a Natural Language Processor (NLP) 502. NLP 502 may include any device, mechanism, system, network, and/or compilation of instructions for performing natural language recognition of voice, text, keywords and phrases, consistent with the technology described herein. In the configuration illustrated in FIG. 5, NLP 502 may include an interface 504, a semantic analyzer 506, a Master and Metadata Search (MMDS) 508, an interpreter 510, and/or an actuator 512. In certain embodiments, components 504, 506, 508, 510, and/or 512 may each be implemented via any combination of hardware, software, and/or firmware.

Interface 504 may serve as an entry point or user interface through which one or more structured or unstructured words or sentences, describing a risk mitigation workflow, may be entered for subsequent recognition using an automatic recognition of control parts.

In certain embodiments, interface 504 may facilitate information exchange among and between NLP 502 and one or more users or systems. Interface 504 may be implemented by one or more software, hardware, and/or firmware components. Interface 504 may include one or more logical components, processes, algorithms, systems, applications, and/or networks. Certain functions embodied by interface 504 may be implemented by, for example, HTML, HTML with JavaScript, C/C++, Java, etc. Interface 504 may include or be coupled to one or more data ports for transmitting and receiving data from one or more components coupled to NLP 502. Interface 504 may include or be coupled to one or more user interfaces (UI).

In certain configurations, interface 504 may interact with one or more applications running on one or more computer systems. Interface 504 may, for example, embed functionality associated with components of NLP 502 into applications running on a computer system. In one example, interface 504 may embed NLP 502 functionality into a Web browser or interactive menu application with which a user interacts. For instance, interface 504 may embed GUI elements (e.g., dialog boxes, input fields, textual messages, etc.) associated with NLP 502 functionality in an application with which a user interacts. Details of applications with which interface 504 may interact are discussed in connection with FIGS. 1-9.

In certain embodiments, interface 504 may include, be coupled to, and/or integrate one or more systems and/or applications, such as speech recognition facilities and Text-To-Speech (TTS) engines. Further, interface 504 may serve as an entry point to one or more voice portals. Such a voice portal may include software and hardware for receiving and processing instructions from a user via voice. The voice portal may include, for example, a voice recognition function and an associated application server. The voice recognition function may receive and interpret dictation, or recognize spoken commands. The application server may take, for example, the output from the voice recognition function, convert it to a format suitable for other systems, and forward the information to those systems.

Consistent with embodiments of the present invention, interface 504 may receive natural language queries (e.g., word, phrases or sentences) from a user and forward the queries to semantic analyzer 506.

Semantic analyzer 506 may transform natural language queries into semantic tokens. Semantic tokens may include additional information, such as language identifiers, to help provide context or resolve meaning. Semantic analyzer 506 may be implemented by one or more software, hardware, and/or firmware components. Semantic analyzer 506 may include one or more logical components, processes, algorithms, systems, applications, and/or networks. Semantic analyzer 506 may include stemming logic, combinatorial intelligence, and/or logic for combining different tokenizers for different languages. In one configuration, semantic analyzer 506 may receive an ASCII string and output a list of words. Semantic analyzer 506 may transmit generated tokens to MMDS 508 via standard machine-readable formats, such as the eXtensible Markup Language (XML).

MMDS 508 may be configured to retrieve information using tokens received from semantic analyzer 506. MMDS 508 may be implemented by one or more software, hardware, and/or firmware components. MMDS 508 may include one or more logical components, processes, algorithms, systems, applications, and/or networks. In one configuration, MMDS 508 may include an API, a searching framework, one or more applications, and one or more search engines.

MMDS 508 may include an API, which facilitates requests to one or more operating systems and/or applications included in or coupled to MMDS 508. For example, the API may facilitate interaction between MMDS 508 and one or more structured data archives (e.g., knowledge base).

In certain embodiments, MMDS 508 may be configured to maintain a searchable data index, including metadata, master data, metadata descriptions, and/or system element descriptions. For example, the data index may include readable field names (e.g., textual) for metadata (e.g., table names and column headers), master data (e.g., individual field values), and metadata descriptions. The data index may be implemented via one or more hardware, software, and/or firmware components. In one implementation, a searching framework within MMDS 508 may initialize the data index, perform delta indexing, collect metadata, collect master data, and administer indexing. Such a searching framework may be included in one or more business process applications.

In certain configurations, MMDS 508 may include or be coupled to a low level semantic analyzer, which may be embodied by one or more software, hardware, and/or firmware components. The semantic analyzer may include components for receiving tokens from semantic analyzer 506 and identifying relevant synonyms, hypernyms, etc. In one embodiment, the semantic analyzer may include and/or be coupled to a table of synonyms, hypernyms, etc. The semantic analyzer may include components for adding such synonyms as supplements to the tokens.

Consistent with embodiments of the present invention, MMDS 508 may leverage various components and searching techniques/algorithms to search the data index using tokens received by semantic analyzer 506. MMDS 508 may leverage one or more search engines that employ partial/fuzzy matching processes and/or one or more Boolean, federated, or attribute searching components. Although, one skilled in the art will appreciate other approaches to identify these similar elements may be used or contemplated within the scope of the technology described herein.

In certain configurations, MMDS 508 may include and/or leverage one or more information validation processes. In one configuration, MMDS 508 may leverage one or more languages for validating XML information. MMDS 508 may include or be coupled to one or more clients that include business application subsystems.

In certain configurations, MMDS 508 may include one or more software, hardware, and/or firmware components for prioritizing information found in the data index with respect to the semantic tokens. In one example, such components may generate match scores, which represent a qualitative and/or quantitative weight or bias indicating the strength/correlation of the association between elements in the data index and the semantic tokens.

In one configuration, MMDS 508 may include one or more machine learning components to enhance searching efficacy as discussed further in association with FIG. 6. In one example, such a learning component may observe and/or log information associated with controls and may build additional and/or prioritized indexes for fast access to frequently used or requested data. Learning components may be forwarded to and/or included in interpreter 510.

Interpreter 510 may process and analyze results returned by MMDS 508. Interpreter 510 may be implemented by one or more software, hardware, and/or firmware components. Interpreter 510 may include one or more logical components, processes, algorithms, systems, applications, and/or networks. In one example, interpreter 510 may include a network, in which control parts are matched to business process rules against tokenized natural language queries and contextual information.

Consistent with embodiments of the present invention, interpreter 510 may be configured to recognize information identified by MMDS 508. For example, interpreter 510 may identify ambiguities, input deficiencies, imperfect conceptual matches, and compound commands. In certain configurations, interpreter 510 may initiate, configure, and manage risk mitigation inputs/outputs; specify and manage configurable policies; perform context awareness processes; maintain context information; personalize policies and perform context switches; and perform learning processes.

Interpreter 510 may provide one or more winning combinations of data elements to actuator 512. Interpreter 510 may filter information identified by MMDS 508 in order to extract information that is actually relevant to textual inputs. That is, interpreter 510 may distill information identified by MMDS 508 down to information that is relevant to the words/sentences and in accordance with intent. Information provided by interpreter 510 (e.g., winning combination of elements) may include function calls, metadata, and/or master data. In certain embodiments, the winning combination of elements may be arranged in specific sequence to ensure proper actuation. Further, appropriate relationships and dependencies among and between various elements of the winning combinations may be preserved/maintained. For example, Meta and master data elements included in a winning combination may be used to populate one or more function calls included in that winning combination.

Actuator 512 may process interpreted information provided by interpreter 510. Actuator 512 may be implemented by one or more software, hardware, and/or firmware components. Actuator 512 may include one or more logical components, processes, algorithms, systems, applications, and/or networks. Actuator 512 may be configurable to interact with one or more system environments.

Consistent with embodiments of the present invention, actuator 512 may be configured to provide information to one or more users/systems. In such embodiments, actuator 512 may interact with one or more information display devices (e.g., Monitor UI 310).

In certain embodiments, actuator 512 may be configured to send requests to one or more devices and/or systems using, for example, various APIs. Actuator 512 may generate one or more presentations based on responses to such commands.

For clarity of explanation, interface 504, semantic analyzer 506, MMDS 508, interpreter 510, and actuator 512 are described as discrete functional elements within NLP 502. However, it should be understood that the functionality of these elements and components may overlap and/or may exist in fewer elements and components. Moreover, all or part of the functionality of these elements may co-exist or be distributed among several geographically-dispersed locations.

FIG. 6 is a block diagram of a machine learning system, according to some embodiments. The machine learning system is a framework that unites several control components to codify, execute and monitor business process models, rules, control code and procedures.

A machine learning system 600 may include a machine learning engine 602 of one or more servers (cloud or local) processing text, such as words, phrases or sentences, to recognize relationships of the words (e.g., within sentences) received by interface 504 of natural language system 500. For example, a risk manager enters, into the UI, a risk mitigation textual description of a control they are constructing. The textual description may be structured (e.g., using known control constructs) or unstructured (e.g., freeform). The natural language processor 502 may break down the structured or unstructured text to determine control related “parts” and a context of these parts. The control parts may describe various control concepts, such as, inputs, outputs, parties involved, risk levels, standards, triggers, actions, mitigation steps, tasks, follow-up, etc. Trained machine learning models 606, such as Control Mapping Model 622, receive this information from the NLP and extract or infer relationships of these control parts to generate, for example, controls as business process models, rules, control code and/or procedures. While described hereafter in stages, the sequence may include more or less stages or be performed in a different order.

Machine learning involves computers discovering how they can perform tasks without being explicitly programmed to do so. Machine learning (ML) includes, but is not limited to, artificial intelligence, deep learning, fuzzy learning, supervised learning, unsupervised learning, etc. Machine learning algorithms build a model based on sample data, known as “training data”, in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning). Machine learning engine 602 may use various classifiers to map concepts associated with a specific language structure to capture relationships between concepts and words/phrases/sentences. The classifier (discriminator) is trained to distinguish (recognize) variations. Different variations may be classified to ensure no collapse of the classifier and so that variations can be distinguished.

Machine learning may involve computers learning from data provided so that they carry out certain tasks. For more advanced tasks, it can be challenging for a human to manually create the needed algorithms. This may be especially true of teaching approaches to correctly identify text patterns and associated control parts associated within varying unstructured text structures. The discipline of machine learning therefore employs various approaches to teach computers to accomplish tasks where no fully satisfactory algorithm is available. In cases where vast numbers of potential answers exist, one approach, supervised learning, is to label some of the correct answers as valid. This may then be used as training data for the computer to improve the algorithm(s) it uses to determine correct answers.

In a first training stage, training data set 604 may, in some embodiments, reflect text (i.e., unstructured or structured) of controls 610, control templates 612, control rules 614, etc. Machine learning engine 602 may ingest all or parts of the training data set to train various ML models 606. Training data may change from model-to-model and each model 606 may select which parts of the training data are more important for the class value they are training to predict (e.g., weighting certain parts more or less, relative to the other parts).

Training a model means learning (determining) values for weights as well as inherent bias from labeled examples. In supervised learning, a machine learning algorithm builds a model by examining many examples and attempting to find a model that minimizes loss; this process is called empirical risk minimization. A language model assigns a probability of a next word occurring in a sequence of words. A conditional language model is a generalization of this idea: it assigns probabilities to a sequence of words given some conditioning context.

As previously described, the technology disclosed herein provides a framework that utilizes machine learning (ML) models to extract controls segments from structured or unstructured risk mitigation descriptive text. In a non-limiting example, the technology disclosed herein implements a control mapping model 622 for automatically learning how to map text to codified controls in the form of process model workflows (e.g., business process models), rules, procedures and control code. Using industry standards like BPMN and DMN as target output, a machine learning model can derive workflow, rules and procedures that can be turned into code by a processing engine. In some embodiments, the technology described herein implements a plurality of machine learning models related to controls combined in an infrastructure (e.g., FIG. 3) to support controls in real-time while interacting with managers and auditors.

A machine learning model 606 may be trained on, for example, hundreds or thousands of freeform text controls, control templates and control rules, and may be implemented with actively developed open source toolkits. The underlying model methodology may leverage any of GMMHMM (Gaussian mixture modeling and hidden Markov modeling), Ngram language modeling, and deep neural networks (DNN). Lower error rates may be achieved by continuous training and fine-tuning of the model. In some embodiments, the machine learning models are supervised in that, based on text of controls 610, control templates 612, control rules 614, an output control is correlated. For example, the question “based on a specific set of freeform text, control templates and control rules, what would an executable resultant control be?” is provided with a corresponding answer of a known previous control. This process is repeated for hundreds or thousands controls. While described in an exemplary embodiment for supervised learning, unsupervised learning may be substituted without departing from the scope of the technology described herein.

In one embodiment, once the model is trained, the aforementioned processes may be performed by successively repeating the processes for one or more text strings of a larger text string, where the one or more text strings contain one or more overlapping windows of text. By performing these processes on overlapping windows of text, the control mapping model 622 can more accurately determine the relevance for each word in a text string, because the overlapping windows of text allow the control mapping model 622 to determine the context for each word of the text string by looking at the words before and after the word in relation to multiple combinations of words in the text string such that the control mapping model 622 can determine how the word is used in the text string (i.e., context).

In a second case example, in some embodiments, the technology disclosed herein implements a machine learning method to automatically locate suitable existing controls for new or amended laws, regulations, policies, standards, and procedures. In this second case, the similar controls model 624 is trained to recognize similarities of text of controls 610 with previously generated controls. Continuing with the earlier call center example, words or phrases frequently found to be associated with a credit card control may be highly weighted to determine future credit card controls in the ML models. Alternatively, or in addition to, the training data 604 may be modified or augmented to include laws, regulations, policies, standards, and procedures. Once trained, the machine learning system may perform classifications to detect similar controls for new data applied to the trained Similar Controls Model 624, such as freeform text in new data (i.e., new text of controls 616).

In a third case example, in some embodiments, the technology disclosed herein provides automatically monitoring of existing controls using machine learning processing models. In this case, the Monitoring Model 626 is trained to automatically instantiate a previously generated control to prevent and detect compliance with business processes. Alternatively, or in addition to, the training data 604 may be modified or augmented to include triggers, audit processes, successes and failures of controls, etc. In addition, Monitoring Model 626 may receive as a training input outputs from Similar Controls Model 624. Once trained, the machine learning system may perform classifications to extract corresponding control executions, timing, frequency, code, data and processes for newly applied text to the trained Monitoring Model 626.

In a second stage, the training cycle continuously looks at results, measures accuracy and fine-tunes the inputs to the modeling engine (feedback loop 607) to improve capabilities of the various ML models 606.

In addition, as various ML models (algorithms) 606 are created, they are stored in a database (not shown). For example, as the training sets are processed through the machine learning engine 602, the ML models 606 may change (tuning/fine tuning) and therefore may be recorded/updated in the database.

Future new data 608 (e.g., New Text of Controls 616, New Control Templates 618 or New Control Rules 620) may be subsequently evaluated with the trained ML models 606. While text, templates and rules have been described as “training data” and “new data” inputs to the machine learning engine 602, these are but examples. Training data may be modified to provide any risk mitigation related data available without departing from the scope of the technology described herein.

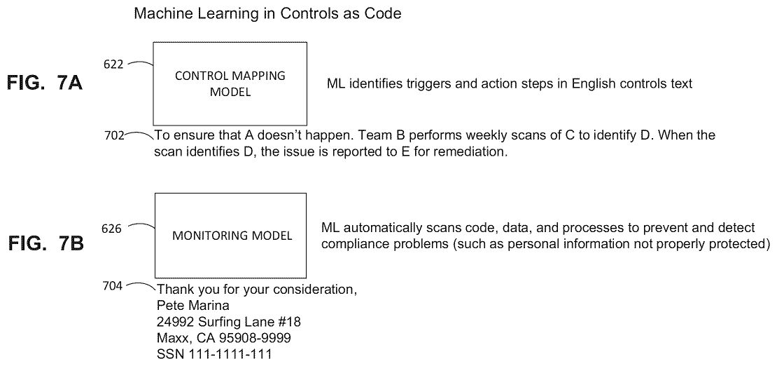

FIG. 7A is an example machine learning process for codification of controls as business process models, rules, control code and procedures. Control Mapping Model 622 receives text describing a risk mitigation 702. In this example, the text reads:
“To ensure that A doesn't happen, Team B performs weekly scans of C to identify D. When the scan identifies D, the issue is reported to E for remediation.”

In this sample text, the originator of the control has a goal to prevent A from happening (i.e., risk). As previously described, control parts may include, inputs, outputs, parties involved, risk levels, standards, triggers, actions, mitigation steps, tasks, follow-up, etc. In this example, the parties involved are “Team B” and “E”, inputs are “C”, outputs are “D”, triggers are “weekly”, tasks are “scanning C”, mitigation is “reporting to E” and follow-up is “remediation”.

FIG. 7B is an example machine learning process for monitoring of controls. As shown, Monitoring Model 626 executes a “personal information check” control to comply with personal data protection requirements of a customer. In this example, Monitoring Model 626 has been trained to recognize personal data and execute corresponding control code. The model automatically scans this control code, data and processes to prevent and detect compliance problems, such as, personal information not properly protected. In the example, a document 704 is scanned for protected info, such as, name, address, and social security information. The execution record (e.g., task successes or failures) of this control is streamed to an uneditable archive as audit evidence 118.

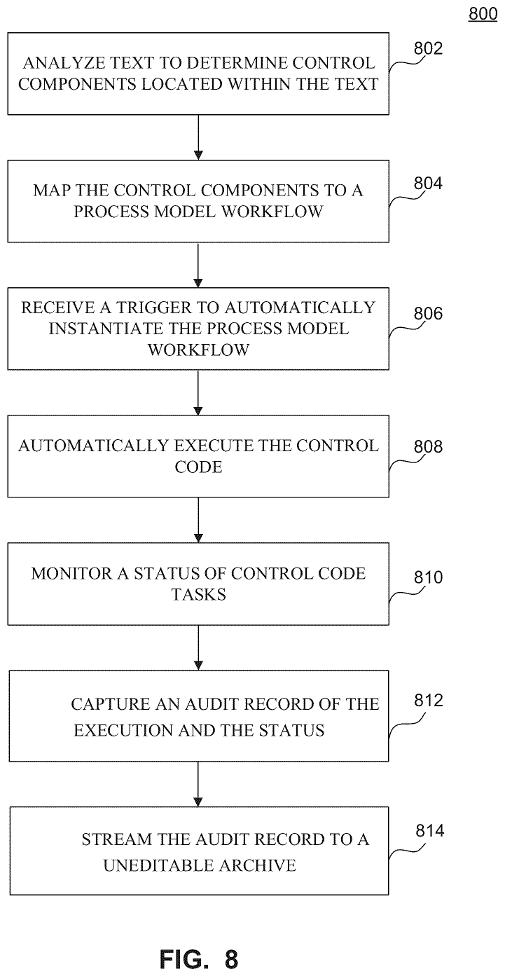

FIG. 8 is a flow diagram for real-time control processing, according to some embodiments. In 802, the risk control system 100 analyzes text to determine control components located within the text, where the text defines one or more measures to provide assurance of compliance with organizational process requirements. For example, a risk manager identifies a risk, formulates a control description to mitigate the risk and enters the control in text into the NLP interface through a UI.

In 804, the risk control system 100 maps, by a control mapping model 622, the control components to a process model workflow, rules, procedures and control code, wherein the process model workflow is executable based on the control code. For example, control mapping model 622 automatically converts the control into a Business Process Model and Notation (BPMN) workflow. Subsequent to creation, a risk manager may post edits the BPMN workflow for accuracy using the UI. The new control is then added to the controls system of record (e.g., list of available controls) and streamed to a tamperproof archive (controls 116 of repository 114).

In 806, the risk control system 100 receives a trigger to automatically instantiate the process model workflow. For example, at an appropriate time, as triggered by a scheduler (every Monday at 6 AM), monitor (e.g., keyword monitor), or a specific events (deposit over $10,000), the control is executed.

In 806, the risk control system 100 automatically executes, in response to the trigger, the control code, wherein the control code comprises at least one or more tasks. For example, automated steps of the control are executed automatically. However, if a step of the control is manual, a human completes the step using a UI.

In 810, the risk control system 100 monitors, in real-time, a status of the one or more tasks as the control is being executed. For example, each task is completed or not completed and is successful or not successful.

In 812, the risk control system 100 captures, in real-time, an audit record of the execution and the status. For example, the system records parts of an executed control (e.g., inputs, outputs, entities, tasks, actions, rules, mitigation, follow-up, to name a few. The audit record also includes a status (successfully completed, failure, etc.) of the action parts, such as tasks, actions, etc.

In 814, the risk control system 100 streams the audit record to an uneditable archive. For example, the execution of all manual and automated steps of the control is streamed as Audit Evidence 118. Executions of the control and summary information (e.g., status) about all controls are may be rendered in a Dashboard UI. In addition, audits may be executed and displayed by retrieving the audit record from Audit evidence 118.

FIG. 9 is example of a UI dashboard to monitor controls. As shown, dashboard 902 includes real-time status of controls. The dashboard may aggregate a company's controls or filter the information into subsets based on risks, urgency, location, product lines, to name a few. A top line 904 reflects numerical analytics. While shown for ‘controls executed’, ‘number of controls’, ‘new controls’ and ‘failures’, any suitable control analytics may be selected for displayed. Dashboard component 906 displays a descending listing of the most popular controls. Dashboard component 908 displays alerts for failed controls. The alerts may be arranged by urgency, frequency, time, etc. Dashboard component 910 displays a graph of controls success rate over a selected time period (e.g., years). Dashboard component 912 provides a fraud alert entry point where a selection may list and organize specific fraud alerts, such as, multi-factor authorization (MFA) fraud. Dashboard component 914 displays previous audits and their status (e.g., succeeded) and additional audit details.

One benefit of centralizing controls is to facilitate their work (e.g., regulatory compliance, training opportunities, etc.) and save time. Another benefit is utilizing these controls for downstream ML models to increase a model's effectiveness in understanding customer behavior.

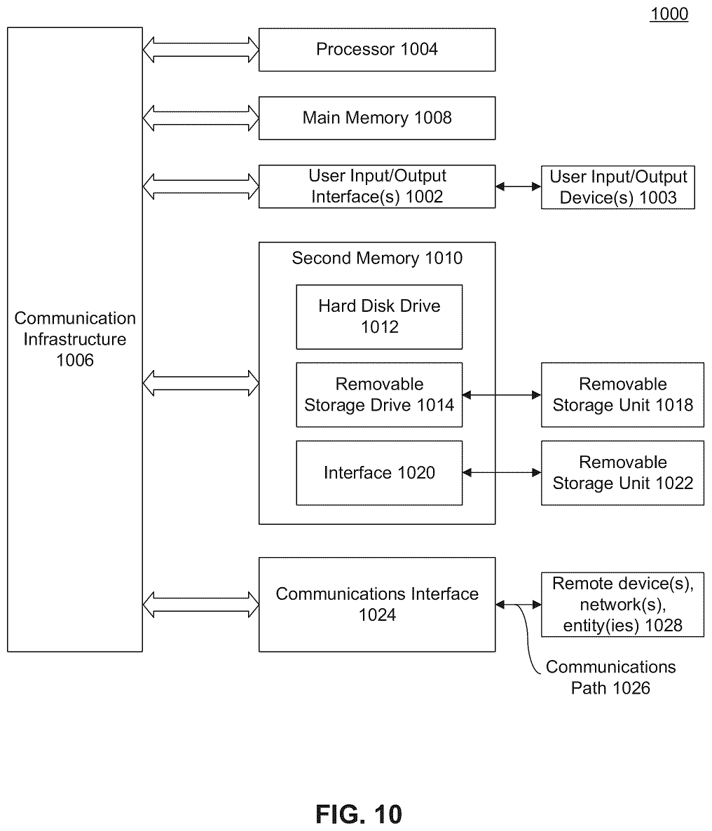

Various embodiments can be implemented, for example, using one or more computer systems, such as computer system 1000 shown in FIG. 10. Computer system 1000 can be any computer capable of performing the functions described herein. Computer system 1000 can be any well-known computer capable of performing the functions described herein.

Computer system 1000 includes one or more processors (also called central processing units, or CPUs), such as a processor 1004. Processor 1004 is connected to a communication infrastructure or bus 1006.

One or more processors 1004 may each be a graphics-processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 also includes user input/output device(s) 1003, such as monitors, keyboards, pointing devices, etc., that communicate with communication infrastructure 1006 through user input/output interface(s) 1002. Computer system 1000 also includes a main or primary memory 1008, such as random access memory (RAM). Main memory 1008 may include one or more levels of cache. Main memory 1008 has stored therein control logic (e.g., computer software) and/or data. Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 includes a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 reads from and/or writes to removable storage unit 1018 in a well-known manner.

According to an exemplary embodiment, secondary memory 1010 may include other means, instrumentalities or other approaches for allowing computer programs and/or other instructions and/or data to be accessed by computer system 1000. Such means, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 enables computer system 1000 to communicate and interact with any combination of remote devices, remote networks, remote entities, etc. (individually and collectively referenced by reference number 1028). For example, communication interface 1024 may allow computer system 1000 to communicate with remote devices 1028 over communications path 1026, which may be wired, and/or wireless, and which may include any combination of LANs, WANs, the Internet, etc. Control logic and/or data may be transmitted to and from computer system 1000 via communication path 1026.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
a memory; and
at least one processor coupled to the memory and configured to perform operations comprising:
analyzing text to determine control components located within the text, wherein the text defines one or more measures to provide assurance of compliance with organizational process requirements,
mapping, by a machine learning model, the control components to a process model workflow, wherein the process model workflow is executable based on corresponding control code,
executing the control code in response to receipt of a trigger to automatically instantiate the process model workflow, wherein the control code comprises one or more tasks,
capturing, in real-time, an audit record of the execution and a status of the one or more tasks, and
streaming the audit record to an uneditable archive.

2. The system of claim 1, the at least one processor further configured with:
a first machine learning classifier to extract the tasks from the text;
a second machine learning classifier to extract inputs from the text;
a third machine learning classifier to extract outputs from the text; or
a fourth machine learning classifier to extract actions from the text.

3. The system of claim 2, wherein the control code further comprises the inputs, the outputs or the actions.

4. The system of claim 2, the at least one processor further configured to perform operations comprising:
monitoring a status of the inputs, the outputs or the actions.

5. The system of claim 2, the at least one processor further configured to perform operations comprising:
a fifth machine learning classifier to extract named entities from the text.

6. The system of claim 5, wherein the control code further comprises one or more of the named entities.

7. The system of claim 5, the at least one processor further configured to perform operations comprising:
capturing, in real-time, an audit record of the one or more named entities.

8. The system of claim 5, the at least one processor further configured with:
a fifth machine learning classifier to extract named entities from the text.

9. The system of claim 8, the at least one processor further configured with:
a sixth machine learning classifier to extract relationships of the named entities.

10. The system of claim 1, the at least one processor further configured to perform operations comprising:
securely storing, in the uneditable archive, a timeline of the executions; and
preventing modifications to the timeline.

11. The system of claim 1, wherein the process model workflow follows business process rules associated with the control components.

12. The system of claim 1, wherein the text is unstructured text.

13. A computer implemented method, the method comprising:
analyzing, by a natural language processor, text to determine control components located within the text, wherein the text defines one or more measures to provide assurance of compliance with organizational process requirements,
mapping, by a machine learning model, the control components to a process model workflow, wherein the process model workflow is executable based on corresponding control code,
executing the control code in response to receipt of a trigger to automatically instantiate the process model workflow, wherein the control code comprises one or more tasks,
capturing, in real-time, an audit record of the execution and a status of the one or more tasks, and
streaming the audit record to a uneditable archive

14. The method of claim 13, further comprising:
extracting, by a first machine learning classifier, the tasks from the text;
extracting, by a second machine learning classifier, inputs from the text;
extracting, by a third machine learning classifier, outputs from the text;
extracting, by a fourth machine learning classifier, actions from the text;
extracting, by a fifth machine learning classifier, named entities from the text; or
extracting, by a sixth machine learning classifier, relationships of the named entities.

15. The method of claim 13, further comprising:
monitoring a status of the inputs, the outputs, the actions or the named entities.

16. The method of claim 13, further comprising:
capturing a status of manual steps within the process model workflow as part of the audit record.

17. The method of claim 13, further comprising:
securely storing, in the uneditable archive, a timeline of the executions; and
preventing modifications to the timeline.

18. The method of claim 13, wherein the process model workflow follows business process rules associated with the control components.

19. The method of claim 13, wherein the text is unstructured text.

20. A non-transitory computer-readable device having instructions stored thereon that, when executed by at least one computing device, causes the at least one computing device to perform operations comprising:
analyzing text to determine control components located within the text, wherein the text defines one or more measures to provide assurance of compliance with organizational process requirements,
mapping, by a machine learning model, the control components to a process model workflow, wherein the process model workflow is executable based on corresponding control code,
executing the control code in response to receipt of a trigger to automatically instantiate the process model workflow, wherein the control code comprises one or more tasks,
capturing, in real-time, an audit record of the execution and a status of the one or more tasks, and
streaming the audit record to a uneditable archive
